(19) United States
(12) Patent Application Publication
(10) Pub. No.: US 2013/0271657 A1
(43) Pub. Date: Oct. 17, 2013

(54) RECEIVING APPARATUS FOR PROVIDING HYBRID SERVICE, AND HYBRID SERVICE PROVIDING METHOD THEREOF

(71) Applicants: Electronics and Telecommunications Research Institute, (US); SAMSUNG ELECTRONICS CO., LTD., Suwon-si (KR)

(72) Inventors: Hong-seok PARK, Ansan-si (KR); Kug-jin YUN, Daejeon (KR); Jae-jun LEE, Suwon-si (KR); Jin-young LEE, Daejeon (KR); Hyun-jeong YIM, Seoul (KR); Yong-seok JANG, Hwaseong-si (KR); Won-sik CHEONG, Daejeon (KR); Yu-sung JOO, Yongin-si (KR); Nam-ho HUR, Daejeon (KR); Sung-oh HWANG, Yongin-si (KR); Hyoung-jin KWON, Cheongju-si (KR); Hee-jean KIM, Yongin-si (KR); Gwang-soon LEE, Daejeon (KR); Seong-sin JOO, Suwon-si (KR)

(73) Assignees: Electronics and Telecommunications Research Institute, Daejeon (KR); Samsung Electronics Co., Ltd., Suwon-si (KR)

(21) Appl. No.: 13/863,019

(22) Filed: Apr. 15, 2013

Related U.S. Application Data
(60) Provisional application No. 61/696,450, filed on Sep. 4, 2012.
(60) Provisional application No. 61/623,789, filed on Apr. 13, 2012.

(30) Foreign Application Priority Data
Nov. 22, 2012 (KR) 10-2012-0133017

(51) Int. Cl. H04N 9/44

(52) U.S. Cl. CPC H04N 9/44
USPC 348/525

(57) ABSTRACT

A receiving apparatus includes a first receiving unit that receives signaling information and a first signal comprising reference data through a radio frequency broadcast network; a control unit that detects a plurality of additional data source information from the signaling information; a second receiving unit that accesses an internet protocol communication network, and receives a second signal comprising additional data from a source apparatus corresponding to each of the plurality of additional data source information; a storage unit that stores the reference data contained in the first signal and the additional data contained in the second signal; and an output unit that processes, synchronizes and outputs each of the reference data and additional data.

### CROSS-REFERENCE TO RELATED APPLICATIONS

This application claims priority from U.S. provisional applications No. 61/623,789, filed Apr. 13, 2012, and No. 61/696,450, filed Sep. 4, 2012, in the United States Patent & Trademark Office, and claims priority from Korean Patent Application No. 10-2012-133017, filed Nov. 22, 2012, in the Korean Intellectual Property Office, the disclosures of which are incorporated herein by reference in their entirety.

### BACKGROUND

1. Field

Apparatuses and methods consistent with exemplary embodiments relate to a receiving apparatus and a hybrid service providing method thereof. More particularly, the present disclosure relates to a receiving apparatus to provide a hybrid service that processes, synchronizes, and outputs a plurality of signals received through different paths, and a hybrid service providing method thereof.

2. Description of the Related Art

Thanks to the development of electronic technology, various types of electronic apparatuses have been developed and spread. A receiving apparatus such as a TV may be cited as one example of these electronic apparatuses.

Recently, based on improved TV performance, multimedia content such as 3D content or full HD content is being supported. These types of content have data sizes greater than the existing content.

However, a transmission bandwidth used in the broadcast network is limited. Accordingly, there is a limitation on the size of the content that can be transmitted through the current broadcast network. In order to meet the limitation, the resolution of the content inevitably needs to be reduced, and, as a consequence, there is a problem that the image quality thereof is degraded.

Attempts to provide various kinds of media data through various transmission environments have been made in order to solve these problems. However, since those data are transmitted through different paths, there is a problem that the receiving apparatus cannot know whether those data are relevant to each other, and thus cannot appropriately synchronize those data.

Accordingly, the need for ways to adequately synchronize those contents has emerged.

### SUMMARY

The present disclosure has been developed in order to overcome the above drawbacks and other problems associated with the conventional arrangement. An aspect of the present disclosure is to provide a receiving apparatus that provides a hybrid service that receives, synchronizes, and outputs a plurality of signals transmitted through different networks, and a hybrid service providing method thereof.

The above aspect and/or other feature of the present disclosure can substantially be achieved by providing an apparatus, which may include a first receiver configured to receive signaling information and a first signal comprising reference data through a first network; a controller configured to detect a plurality of additional data source information from the signaling information; a second receiver configured to access a second network, and receive a second signal comprising additional data from a source apparatus corresponding to each of the plurality of additional data source information; a storage which stores the reference data contained in the first signal and the additional data contained in the second signal; and an outputter configured to process, synchronize and output each of the reference data and additional data. The first network may be a radio frequency broadcast network and the second network may be an internet protocol communication network.

The signaling information may include first additional data source information related to a source of at least one first additional data of a first content and second additional data source information related to a source of at least one second additional data of a second content that will be output following the first content, and the signaling information corresponding to each content is repeatedly received while corresponding content is being output.

While the first content is being output, the controller may control the second receiver to access the source of the at least one second additional data by using the second additional data source information and to receive the second signal comprising the second additional data, and may store the second additional data in the storage unit.

The signaling information may include a specific value related to a synchronization type of a hybrid service, and the controller may control the outputter so that the reference data and the additional data are synchronized and output, by using synchronizing information corresponding to the specific value.

The specific value may include a first value that relates to performing synchronization by using presentation time stamp (PTS) information of each of the reference data and the additional data, a second value that relates to using time codes contained in an elementary stream (ES) of each of the reference data and the additional data as the synchronizing information, and a third value that relates to using the synchronizing information provided through a private data stream contained in each of the first and second signals.

If the specific value is the first value, the outputter may select unit data that will be synchronized by comparing PTS of the reference data and PTS of the additional data, and may output the selected unit data, if the specific value is the second value, the outputter may select the unit data that will be synchronized by comparing a first time code contained in ES of the reference data and a second time code contained in ES of the additional data, may adjust timestamps of the selected unit data to a same value, and may perform synchronization output in the adjusted timestamp, and, if the specific value is the third value, the output unit may detect the synchronizing information contained in each private data stream, and may perform synchronization output depending on the detected synchronizing information.

The signaling information may include at least one from among the number of hybrid services provided by using the signaling information, a separator of the hybrid service, a providing method of the hybrid service, an indicator to indicate a providing time of the hybrid service, a specific value to specify a synchronization type of the hybrid service, an identifier of the hybrid service, a temporal order of playback of additional data configuring the hybrid service, and an URL information to obtain additional data.

The outputter may include a first detector configured to detect the reference data from the first signal; a first video processor configured to decode the reference data and generate a first video frame; a second detector configured to detect the additional data from the second signal; a second video processor configured to decode the additional data and generate a second video frame; and a renderer configured to combine the first decoded video frame and the second decoded video frame and perform rendering, wherein the controller may selectively control at least one of the first detector, the second detector, the first video processor, the second video processor, and the renderer, and may perform synchronization processing of the reference data and the additional data.

The controller may detect the signaling information from at least one of a reserved area within a program map table (PMT), a PMT descriptor area, a program and system information protocol virtual channel table (PSIP VCT), an event information table (EIT) reserved, an EIT descriptor area, and a private stream.

According to another aspect of the present disclosure, a hybrid service providing method may include receiving signaling information and a first signal comprising reference data through a first network; detecting a plurality of additional data source information from the signaling information; receiving a second signal comprising additional data from a source apparatus corresponding to each of the plurality of additional data source information by accessing a second network; and detecting the reference data and the additional data from each of the first signal and the second signal, respectively, and processing, synchronizing, and outputting the reference data and the additional data.

The signaling information may include first additional data source information related to a source of at least one first additional data of a first content and a second additional data source information related to a source of at least one second additional data of a second content that will be output following the first content, and the signaling information corresponding to each content is repeatedly received in a same form while corresponding content is being output.

The hybrid service providing method may include storing the second additional data if the second signal comprising the second additional data is received based on the second additional data source information while the first content is being output; and outputting, if an event to output the second content occurs, the second content by using the stored second additional data.

The signaling information may include a specific value related to a synchronization type of a hybrid service, and the synchronizing may be performed depending on synchronizing information corresponding to the specific value.

The specific value may include a first value related to performing synchronization by using presentation time stamp (PTS) information of each of the reference data and the additional data, a second value related to using time codes contained in an elementary stream (ES) of each of the reference data and the additional data as the synchronizing information, and a third value related to using the synchronizing information provided through a private data stream contained in each of the first and second signals.

The outputting them may include, if the specific value is the first value, selecting unit data that will be synchronized by comparing PTS of the reference data and PTS of the additional data, and outputting the selected unit data; if the specific value is the second value, selecting the unit data that will be synchronized by comparing a first time code contained in the ES of the reference data and a second time code contained in the ES of the additional data, adjusting timestamps of the selected unit data to a same value, and performing synchronization output based on the adjusted timestamp; and, if the specific value is the third value, detecting the synchronizing information contained in each private data stream, and performing synchronization output depending on the detected synchronizing information.

The signaling information may include at least one from among a number of hybrid services provided by using the signaling information, a separator of the hybrid service, a providing method of the hybrid service, an indicator to indicate a providing time of the hybrid service, a specific value to specify a synchronization type of the hybrid service, an identifier of the hybrid service, a temporal order of playback of additional data configuring the hybrid service, and an URL information to obtain the additional data.

The signaling information may be detected from at least one of a reserved area within a program map table (PMT), a PMT descriptor area, a program and system information protocol virtual channel table (PSIP VCT), an event information table (EIT) reserved, an EIT descriptor area, and a private stream.

As described above, various exemplary embodiments of the present disclosure may provide a hybrid service that separately receives and outputs additional data for each of a plurality of contents by using signaling information.

Other objects, advantages and salient features of the present disclosure will become apparent from the following detailed description, which, taken in conjunction with the annexed drawings, discloses exemplary embodiments.

### BRIEF DESCRIPTION OF THE DRAWINGS

These and/or other aspects and advantages of the present disclosure will become apparent and more readily appreciated from the following description of the exemplary embodiments, taken in conjunction with the accompanying drawings of which:

FIG. 1 is a block diagram illustrating a configuration of a transmitting/receiving system according to an exemplary embodiment of the present disclosure;

FIG. 2 is a block diagram illustrating a configuration of an output unit used in a receiving apparatus according to an exemplary embodiment of the present disclosure;

FIG. 3 is a view illustrating an example of a configuration of signaling information;

FIG. 4 is a view for explaining a signaling information providing method according to an exemplary embodiment of the present disclosure;

FIG. 5 is a table illustrating kinds of specific values of hybrid service synchronization types that are included in signaling information;

FIG. 6 is a view illustrating an example of syntax of signaling information;

FIG. 7 is a table illustrating the kinds of variables that are included in signaling information;

FIG. 8 is a view for explaining a synchronizing information providing method according to an exemplary embodiment of the present disclosure;

FIG. 9 is a view illustrating an example of a structure of synchronizing information when additional data are provided in a form of TS;

FIG. 10 is a view illustrating an example of a structure of synchronizing information when additional data are provided in a form of MP4 file;

FIG. 11 is a view for explaining another method for transmitting signaling information;

FIG. 12 is a view of an example of a structure of EIT where linkage_info_descriptor( ) is defined;

FIG. 13 is a flowchart for explaining a hybrid service providing method according to an exemplary embodiment of the present disclosure;

FIG. 14 is a flowchart for explaining a process for processing additional data;

FIGS. 15, 16, and 17 are views for explaining configurations and operations of transmitting systems according to various exemplary embodiments of the present disclosure.

Throughout the drawings, like reference numerals will be understood to refer to like parts, components and structures.

### DETAILED DESCRIPTION OF THE EXEMPLARY EMBODIMENTS

Hereinafter, certain exemplary embodiments of the present disclosure will be described in detail with reference to the accompanying drawings.

The matters defined herein, such as a detailed construction and elements thereof, are provided to assist in a comprehensive understanding of this description. Thus, it is apparent that exemplary embodiments may be carried out without those defined matters. Also, well-known functions or constructions are omitted to provide a clear and concise description of exemplary embodiments. Further, dimensions of various elements in the accompanying drawings may be arbitrarily increased or decreased for assisting in a comprehensive understanding.

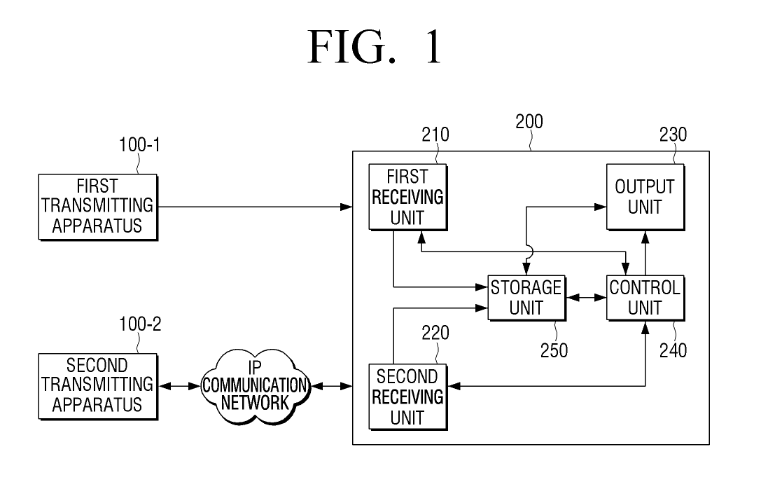

FIG. 1 is a block diagram illustrating a configuration of a transmitting/receiving system according to an exemplary embodiment of the present disclosure. Referring to FIG. 1, a transmitting/receiving system includes a plurality of transmitting apparatuses 100-1 and 100-2, and a receiving apparatus 200.

First and second transmitting apparatuses 100-1 and 100-2 transmit different signals through different paths. For example, the first transmitting apparatus 100-1 may transmit a first signal through a radio frequency (RF) broadcast network, and the second transmitting apparatus 100-2 may transmit a second signal through an internet protocol (IP) communication network.

The first and second signals include different data configuring a single multimedia content, respectively. In other words, the single content may consist of data included in the first signal and data included in the second signal. For example, in the case of 3D content, left eye images and right eye images may be included in the first and second signals, respectively. Alternatively, the content may be divided into video data and audio data, or moving image data and subtitles data, other data, etc. that are included in each of the first and second signals. In this disclosure, data contained in the first signal is referred to as reference data, and data contained in the second signal is referred to as additional data. The receiving apparatus 200 combines the reference data contained in the first signal and the additional data contained in the second signal, thereby outputting a single content. In this disclosure, a service that uses and processes data transmitted through different paths together with each other is referred to as a hybrid service. In other words, processing capacity of the existing broadcast transmitting system may be limited to service a large size of 3D content or high-definition content. Accordingly, the hybrid service may be provided in order to have compatibility with the existing broadcast system and receiving apparatus, and to service a large size of content. In the case of a hybrid service, since a single content is provided through a plurality of different networks, the large size of content may be processed. In this disclosure, a case in which both the broadcast network and IP network are used is disclosed as an example; however, the types and numbers of networks may be implemented in various ways.

Referring to FIG. 1, the receiving apparatus 200 according to an exemplary embodiment of the present disclosure includes a first receiving unit 210, a second receiving unit 220, an output unit 230, a control unit 240, and a storage unit 250. The receiving apparatus 200 may be implemented as various types of apparatuses, such as a television (TV), a cell phone, a tablet PC, a laptop PC, a personal computer (PC), a kiosk, a set top box, a billboard, etc.

The first receiving unit 210 receives signaling information and a first signal including the reference data through the radio frequency (RF) broadcast network. The signaling information includes information about additional data that will be processed together with the reference data included in the first signal, and various kinds of information related to the hybrid service to use the reference data and the additional data. The contents, a structure, and a transmitting method of the signaling information will be described in more detail later.

The control unit 240 controls overall operation of the receiving apparatus 200. In detail, if the signaling information is received through the first receiving unit 210, the control unit 240 detects a plurality of additional data source information from the signaling information.

The additional data source information means address information about a source to provide the additional data. In other words, a single content may be divided into a plurality of unit data. If data that are transmitted through the broadcast network among the divided data are referred to as the reference data (or referred to as basic data, or main data), data that are transmitted through the IP network may be referred to as the additional data. The additional data may be transmitted in a form of real-time transmitting stream or MP4 file.

If it is implemented in the form of a real-time transmitting stream, the second signal including the additional data may be transmitted and received by using a protocol such as a real-time transport protocol (RTP) or a hypertext transfer protocol (HTTP). When the HTTP is used, a metadata file is provided to obtain the second signal. The metadata is information to inform where the multimedia content can be received. The metadata file may include information that a client needs to know in advance such as locations in the content time that correspond to each of the multiple divided files, URLs of the sources that will provide the corresponding files, size, etc. The metadata file may be classified in a variety of types depending on the kinds of HTTP-based streaming. In other words, in the case of a smooth streaming manner, an internet information service (IIS) smooth streaming media (ism) file may be used as the metadata file. In the case of an internet engineering task force (IETF) hypertext transfer protocol (HTTP) live streaming manner, an m3v8 file may be used as the metadata file. In cases of an adaptive HTTP streaming Rel. 9 employed in Third Generation Partnership Project (3GPP), an adaptive HTTP streaming Rel. 2 employed in Open IPTV Forum (OIPF), and a dynamic adaptive streaming over HTTP manner employed in Motion Pictures Expert Group (MPEG), a media presentation description (MPD) may be used as the metadata file. The additional data source information may be address information for a source from which such metadata file can be obtained.

On the other hand, the additional data configuring a single content may be formed of multiple streams or files. Since the additional data should be processed, synchronized, and outputted with the reference data in order to provide a single intact content, the additional data should be downloaded in real-time or previously. Accordingly, in the present exemplary embodiment, the first transmitting apparatus 100-1 to transmit the reference data may provide together the signaling information including a plurality of additional data source information.

In the above description, the signaling information is provided together with the reference data; however, it is not necessarily implemented as such. The signaling information may be provided from a separate apparatus.

The second receiving unit 220 accesses the internet protocol (IP) communication network, and receives the second signal including additional data from a source apparatus corresponding to each of a plurality of additional data source information. In the exemplary embodiment of FIG. 1, the second transmitting apparatus 100-2 is illustrated as one source apparatus; however, the additional data may be provided from a plurality of different source apparatuses. The second signal may be transmitted in the real-time stream method or in a file download method.

The control unit 240 may control the second receiving unit 220 to directly access the source apparatus of the additional data by using the additional data source information contained in the signaling information. Also, if the additional data source information is source information for a metadata file, the control unit 240 detects the source information from the signal that is received through the second receiving unit 220, and controls the second receiving unit 220 to obtain the metadata file by accessing the source and to receive the second signal by using the metadata file.

On the other hand, the first signal may include a first data, namely, the reference data, and first synchronizing information, and the second signal may include a second data, namely, the additional data, and second synchronizing information. A variety of information may be used as the first and second synchronizing information. In detail, the synchronizing information may be society of motion picture and television engineers (SMPTE) time codes, frame numbers, and a variety of other information depending on the type thereof, and may be distinguished into a video level, an ES level, a packetized elementary stream (PES) level, etc. depending on the providing method thereof.

The first and second transmitting apparatus 100-1 and 100-2 may provide the synchronizing information in a variety of formats and manners depending on a type of content, a transmission environment, an encoding method, a size of content, etc. The first transmitting apparatus 100-1 may include various types of information required for the hybrid service as well as the synchronizing information in the signaling information, and then, may transmit it.

The storage unit 250 stores the reference data contained in the first signal and the additional data contained in the second signal, respectively. The storage unit 250 may include various storage members such as a flash memory, a hard disk drive (HDD), a random-access memory (RAM), a read-only memory (ROM), a buffer, etc. When the second signal is transmitted in the real-time streaming manner, a buffering operation of the corresponding stream is performed by using a buffer within the storage unit 250. The control unit 240 may process the buffered stream to extract the additional data.

The control unit 240 provides the hybrid service by using the signaling information. In detail, the signaling information may include not only information about additional data of content that is being output currently, but also information about additional data of content that will be output next. In this case, the control unit 240 previously receives the additional data of the next content by using the additional data source information of the next content, and then, stores it in the storage unit 250.

For example, if the signaling information includes first additional data source information to specify a source of at least one first additional data that configures first content, and second additional data source information to specify a source of at least one second additional data that configures second content that will be output following the first content, the control unit 240 controls the second receiving unit 220 to access the source of the at least one second additional data by using the second additional data source information and to receive the second signal including the second additional data while the first content is being output. Accordingly, after the second signal is received, the control unit 240 stores the signal or the second additional data detected from the signal in the storage unit 250.

On the other hand, the signaling information may be repeatedly transmitted in the same form while one content is being output. Accordingly, even if the receiving apparatus 200 is turned on and receives the content after the content starts playing, the receiving apparatus 200 may obtain and process the additional data by using the signaling information received thereafter.

The output unit 230 processes, synchronizes, and outputs the reference data and additional data stored in the storage unit 250. The output unit 230 may include a plurality of data processing units for synchronization output. In other words, the output unit 230 may include not only various components for processing and displaying video data such as a video decoder, a scaler, a frame rate conversion circuit, a display panel, a backlight unit, etc., but also components for processing and outputting audio data such as an audio decoder, an amplifier, a noise filter, a speaker, etc. Multiple components may be provided depending on the number of the receiving signals. For the convenience of description, only the components for processing and displaying the video data are illustrated and described, and illustration and description of the components for the audio data will be omitted hereinafter.

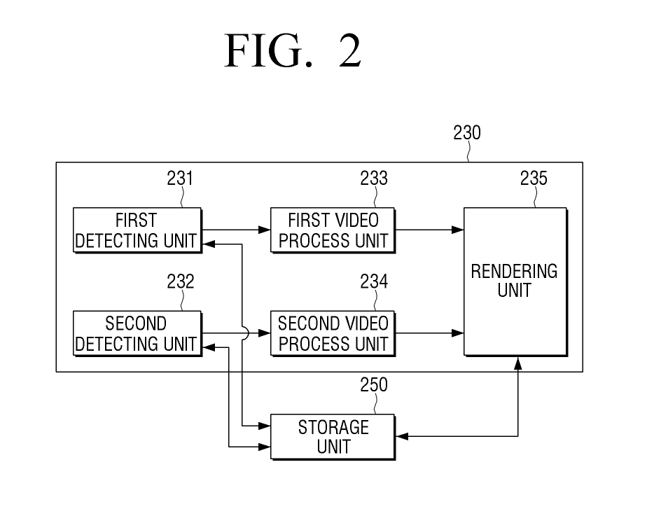

FIG. 2 is a block diagram illustrating an example of a configuration of the output unit 230. Referring to FIG. 2, the output unit 230 includes a first detecting unit 231, a second detecting unit 232, a first video process unit 233, a second video process unit 234, and a rendering unit 235.

The first detecting unit 231 detects the reference data from the first signal, and the first video process unit 233 processes the detected reference data. If the first signal that is received in the first receiving unit 210 is a MPEG2-TS format, the first detecting unit 231 demuxes the received transmitting stream, and then, outputs video ES. In this case, the first video process unit 233 may be implemented as a MPEG2 decoder. Accordingly, the first video process unit 233 decodes the received video ES, and the decoded raw data are provided to the rendering unit 235.

The second detecting unit 232 detects the additional data from the second signal, and the second video process unit 234 processes the detected additional data. As described above, the second signal received in the second receiving unit 220 may be the MPEG2-TS format or a file format. MPEG2-TS means a transmitting stream that is encoded in the MPEG2 encoding method, and is modulated and transmitted in the ATSC 8VSB method. In the case of the transmitting stream like the MPEG2-TS, the second detecting unit 232 detects the video ES by demuxing the received transmitting stream, and provides the video ES to the second video process unit 234. On the other hand, if the second signal is received in the file format, the second detecting unit 232 may be implemented as a file parser. Accordingly, the second detecting unit 232 parses the received file, and then, provides the parsing result to the second video process unit 234. The second video process unit 234 decodes the video data provided from the second detecting unit 232 in the AVC manner, and provides the decoding result to the rendering unit 235. According to an exemplary embodiment, the second signal may be selectively provided in TS or file format. At this case, the second detecting unit 232 has both the demuxer and the file parser, and may detect the additional data by selectively using them depending on the signal format.

The rendering unit 235 combines and performs rendering of the first and second decoded video frames provided from the first and second video process units 233 and 234.

The control unit 240 controls the video frames corresponding to each other to be combined and rendered, thereby performing the synchronization output.

In detail, the decoded data provided from the first and second video process units 233 and 234, namely, raw data, may include synchronizing information such as time codes or frame numbers as a form of watermark. After detecting the synchronizing information of the watermark form contained in each raw data, the rendering unit 235 may directly perform a frame-by-frame synchronization based on the synchronizing information, or, after adjusting a timestamp of each frame, may perform rendering depending on the timestamp.

The synchronization may be performed in a variety of methods depending on the synchronization types. The control unit 240 may determine the synchronization method depending on the signaling information.

For example, the signaling information may include a specific value for specifying the synchronization type of the hybrid service. The control unit 240 controls the output unit 230 to synchronize and output the reference data and the additional data by using the synchronizing information corresponding to the specific value.

In detail, the specific value may be one of a first value to specify to perform synchronization by using presentation time stamp (PTS) information of each of the reference data and the additional data, a second value to specify to use time codes contained in an elementary stream (ES) of each of the reference data and the additional data as the synchronizing information, and a third value to specify to use the synchronizing information that is provided through a private data stream contained in each of the first and second signals.

If the specific value is the first value, the output unit 230 performs synchronization output by comparing PTS of the reference data and PTS of the additional data. On the other hand, if the specific value is the second value, the output unit 230 performs synchronization output by comparing a first time code contained in ES of the reference data and a second time code contained in ES of the additional data, and, if the specific value is the third value, the output unit 230 detects synchronizing information contained in each private data stream, and performs synchronization output depending on the detected synchronizing information.

The control unit 240 selectively controls at least one of the first detecting unit 231, the second detecting unit 232, the first video process unit 233, the second video process unit 234, and the rendering unit 235 depending on the specific value, thereby performing synchronization process of the reference data and additional data.

In detail, if the specific value is the first value, the control unit 240 controls the rendering unit 235 to check PTS of data that are processed in the first video process unit 233 and the second video process unit 234 and are stored in the buffer (not illustrated), and to select unit data that will be synchronized. The rendering unit 235 selects the unit data having the same PTS, thereby performing rendering.

On the other hand, if the specific value is the second value, the control unit 240 controls the first video process unit 233 and the second video process unit 234 to detect the time code from the reference data and the additional data, respectively. The first and second video process units 233 and 234 extract the SMPTE time code that is provided through the ES level, respectively, and provides it to the rendering unit 235. The rendering unit 235 compares the time code of the first signal and the time code of the second signal, and performs synchronization process that synchronizes and outputs frames having the matched time code.

On the other hand, if the specific value is the third value, the control unit 240 controls the first and second detecting units 231 and 232 to detect the synchronizing information from each of the first and second signals. The synchronizing information detected in the first and second detecting units 231 and 232 is provided to the rendering unit 235. The rendering unit 235 performs synchronization output based on the synchronizing information.

The rendering unit 235 may perform synchronization output by a method that selects unit data that will be synchronized, and adjusts the timestamps thereof to the same value. Also, the rendering unit 235 may select unit data that will be synchronized based on the time code or the frame number itself, and may output the unit data together. In the case of the video data, the unit data may be a video frame, and in the case of the audio data, the unit data may be audio data of a time unit corresponding to the predetermined number of video frames.

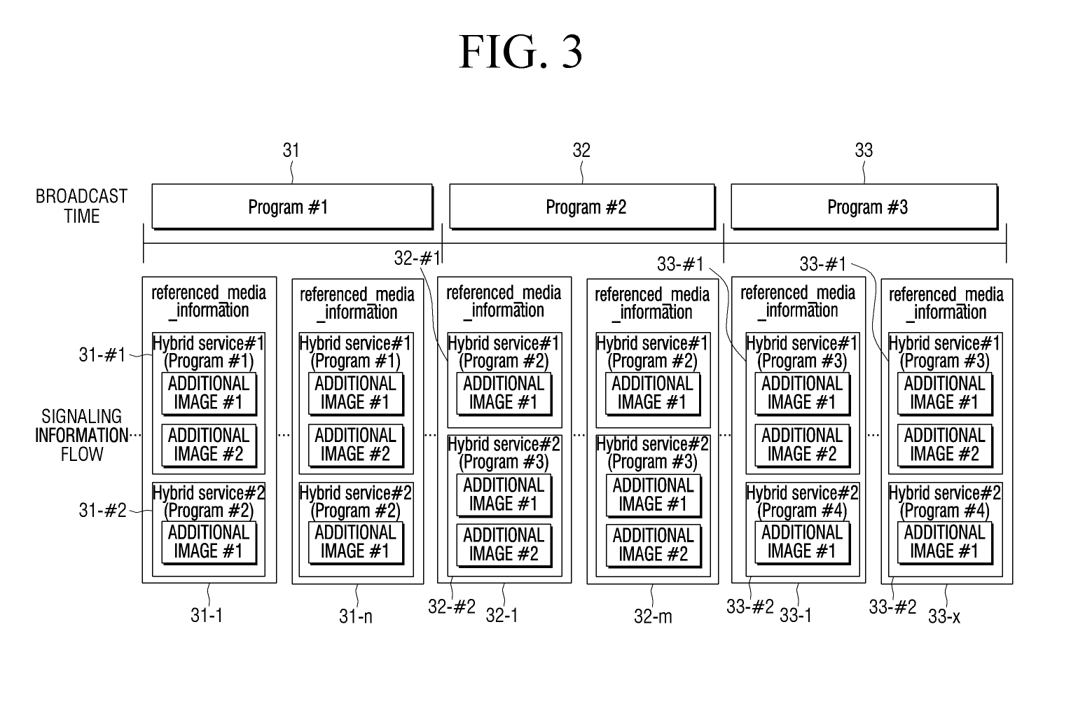

FIG. 3 is a view illustrating an example of a configuration of signaling information that is used in the transmitting/receiving system according to an exemplary embodiment of the present disclosure. Referring to FIG. 3, a plurality of reference data 31, 32 and 33 corresponding to different content is sequentially transmitted depending on the order of time. Each of the reference data 31, 32 and 33 may include video data corresponding to different broadcast programs.

The receiving apparatus 200 may receive the signaling information separately from the reference data. The signaling information may be received from the first transmitting apparatus 100-1 in the same way as the reference data, or, of course, may be received from other new external apparatus.

While the reference data 31 for the first content is being received, the receiving apparatus 200 receives the same type of signaling information multiple times (31-1˜31-n). The structure and contents of the signaling information that is received are the same every time. Accordingly, even if, while one content is already being broadcasted, the receiving apparatus 200 is turned on, the receiving apparatus 200 can receive the additional data by using the signaling information provided thereafter.

Referring to FIG. 3, the first signaling information 31-1˜31-n that is received while the first reference data 31 is being received includes first additional data source information 31-#1 corresponding to the first reference data, and second additional data source information 31-#2 corresponding to the second reference data. The first additional data source information 31-#1 includes information about sources to provide a plurality of additional data (additional images #1, and #2) corresponding to the first reference data 31, respectively. The second additional data source information 31-#2 includes information about a source to provide a single additional data (additional image #1).

On the other hand, the second signaling information 32-1˜32-m that is received while the second reference data 32 is being received includes second additional data source information 32-#1 corresponding to the second reference data, and third additional data source information 32-#2 corresponding to the third reference data. The second additional data source information 32-#1 includes information about a source to provide a single additional data (additional image #1) corresponding to the second reference data 32. The third additional data source information 32-#2 includes information about sources to provide two additional data (additional images #1, and #2) corresponding to the third reference data 33.

As described above, each of signaling information may include also the additional data source information corresponding to reference data that will be received following the reference data that is currently received.

After receiving the additional data in advance by obtaining the additional data source information about the next content, the control unit 240 may store the additional data in the storage unit 250. Accordingly, when playing the next content, the control unit 240 may perform synchronization playback as soon as the reference data is received without an operation to receive the additional data.

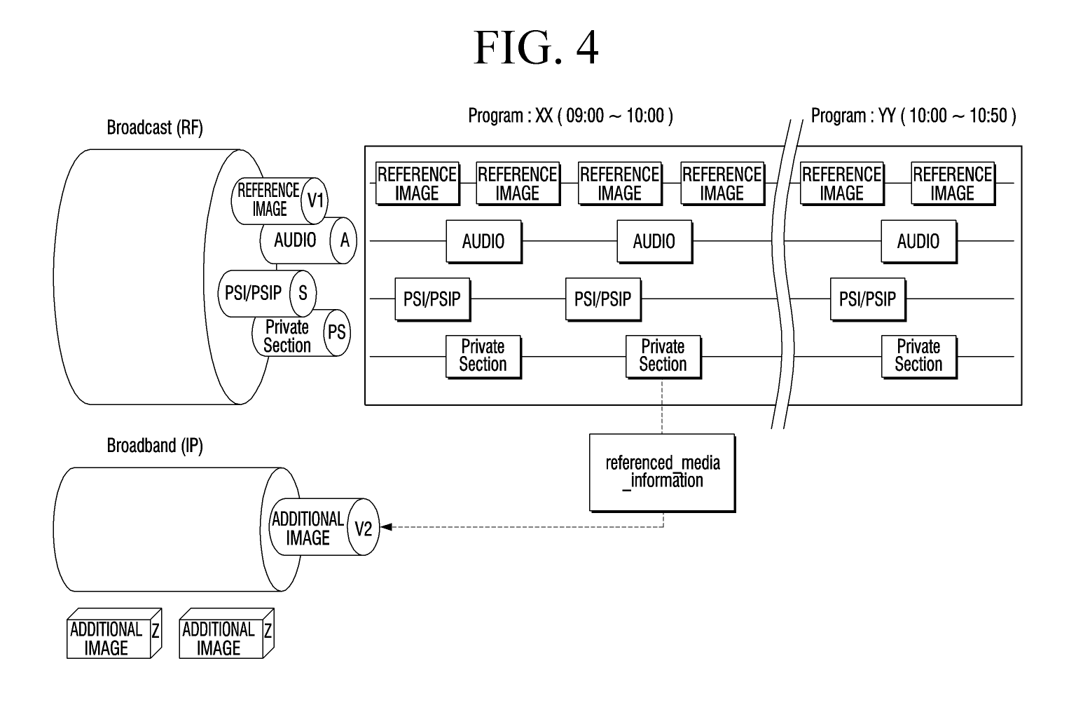

The signaling information may be provided to the receiving apparatus 200 in a variety of manners. FIG. 4 is a view for explaining a method for providing signaling information in a transmitting/receiving system according to an exemplary embodiment of the present disclosure. Referring to FIG. 4, the first signal that is transmitted through the RF broadcast network, according to the MPEG2 standard, may include program specific information/program and system information protocol (PSI/PSIP), private section, etc. in addition to a reference image V1 and audio (A) data. The signaling information may be recorded in the private section. The private section is defined in the MPEG, and is used to transmit system information (SI), data specific to a particular application, a broadcast file system, etc. The signaling information is transmitted through the private section, and the receiving apparatus 200 may detect the signaling information recorded in the private section through section filtering. In FIG. 4, the signaling information is described as referenced_media_information; however, its name may be called variously depending on the need. The receiving apparatus 200 may access the additional data source based on the signaling information recorded in the private section, thereby receiving additional data V2.

As illustrated in FIG. 4, the reference data are transmitted in different time zones by the broadcast programs. In other words, a program XX is received and output during 09:00 to 10:00, and a program YY is received and output during 10:00 to 10:50.

The signaling information may include a variety of information required to implement the hybrid service. In detail, the signaling information may include the number of the hybrid services provided by using the signaling information, a separator of the hybrid service, a providing method of the hybrid service, an indicator to indicate a providing time of the hybrid service, a specific value to define the synchronization type of the hybrid service, an identifier of the hybrid service, the temporal order of playback of additional data configuring the hybrid service, additional data source information for obtaining additional data configuring the hybrid service, etc.

The specific value to define the synchronization type of the hybrid service may be determined depending on the kinds of the synchronizing information, an inserted location of the synchronizing information, etc.

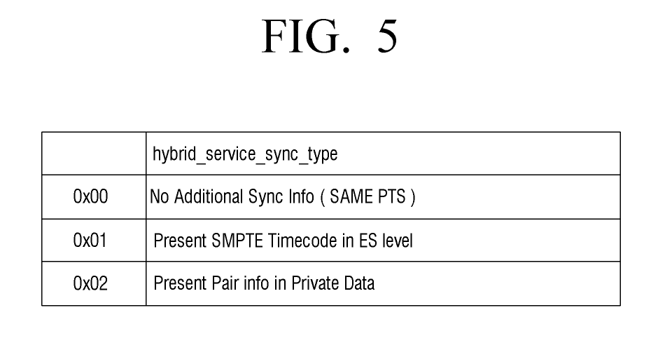

FIG. 5 is a view illustrating examples of specific values to specify the synchronization type. Referring to FIG. 5, the specific value may include 0x00, 0x01, and 0x02.

The first value, namely, 0x00 is a value that specifies to perform synchronization by using the time stamps that the reference data and the additional data have without using separate synchronizing information. According to the MPEG standard, the transmitting stream to transmit the broadcast data includes program clock reference (PCR) and presentation time stamp (PTS). The PCR means reference time information to match the time criteria of the receiving apparatus (a set top box, a TV, etc.) according to the MPEG standard with that of the transmitting apparatuses 100-1 and 100-2. If the specific value is set by 1, the control unit 240 of the receiving apparatus 200 sets the value of system time clock (STC) depending on the PCR. The PTS means a timestamp that indicates a playback time for synchronization of video and audio in a broadcast system according to the MPEG standard. In this disclosure, it is referred to as a timestamp. The control unit 240 controls the output unit 230 to combine and output frames having the same timestamps among video frames within the reference data and video frames within the additional data by checking the timestamp fit to the PCR. For example, in the case of 3D content, the reference data may include left eye images, and the additional data may include right eye images. If the receiving apparatus 200 is an active shutter glasses type, it displays alternately the left eye image and right eye image with the same timestamp. On the other hand, if it is a passive type, the receiving apparatus 200 divides each of the left eye image and right eye image with the same timestamp into a plurality of lines, and then, displays frames configured by combining of odd lines and even lines.

On the other hand, the 0x01 of the specific values is a value to specify to use the time codes contained in elementary stream (ES) of each of the reference data and additional data as the synchronizing information. The time code is a series of pulse signals created by a time code generator, and is a signal standard that has been developed for easy editing management. When creating and editing content, the same time code is used to manage the synchronization of the left eye images and right eye images. Accordingly, the time code may maintain the same pair regardless of the time when the stream is generated or transmitted. In detail, a society of motion picture and television engineers (SMPTE) time code may be used. In other words, SMPTE 12M expresses the time code in the form of “hours: minutes: seconds: frames”. The SMPTE time code may be classified into a longitude time code (LTC) and a vertical interval time code (VITC) depending on the recording method. The LTC may be configured with a total of 80 bits of data including time information (25 bits), user information (32 bits), synch information (16 bits), retention areas (4 bits), and frame mode mark (2 bits). The VITC is recorded in two horizontal lines within a vertical blanking period of the video signal. SMPTE RP-188 defines an interface standard through which the LTC or VITC type of time code can be transmitted as ancillary data.

If the specific value is recorded as the second value, namely, 0x01, the control unit 240 compares a time code recorded in each video frame of the reference data and a time code recorded in each video frame of the additional data. Accordingly, the control unit 240 determines the video frames having the same time code as video frames that are matched to each other, and then, controls the output unit 230 to synchronize and output them.

On the other hand, the 0x02 of the specific values is a value to specify to use the synchronizing information that is provided through a private data stream contained in each of the first and second signals.

The synchronizing information such as the time code or the frame number as described above may be provided through various areas such as a program map table (PMT), a program and system information protocol virtual channel table (PSIP VCT), an event information table (EIT), etc. Alternatively, the synchronizing information may be provided by the private data stream. Here, the frame number means identifying information such as numbers, etc. that is assigned to each of frames. If the specific value is recorded as the third value, namely, 0x02, the control unit 240 detects the synchronizing information from the private data stream, and then, performs synchronization output by using it.

If the specific value is the second value or the third value, the output unit 230 may select video frames that are matched to each other by directly comparing the time code or frame number. Then, the output unit 230 checks a difference value between the timestamps of the selected video frames, and adjusts the timestamps depending on the checked value, thereby achieving the synchronization. Alternatively, the output unit 230 does not adjust the timestamps, but performs operations such as decoding, scaling, rendering, etc. for the video frames based on the time code or the frame number itself, thereby performing synchronization.

FIG. 5 illustrates only three specific values; however, this is only one example. Therefore, various specific values may be used depending on types, recording locations, etc. of the synchronizing information. For example, in addition to the frame number, frame index information, coordinated universal time (UTC) information, etc. may be used as the synchronizing information. The synchronizing information may be transmitted in a variety of levels such as a video level, an ES level, a PES level, etc.

On the other hand, as described above, the signaling information may include a variety of information. Also, the structure of the signaling information may be variously implemented.

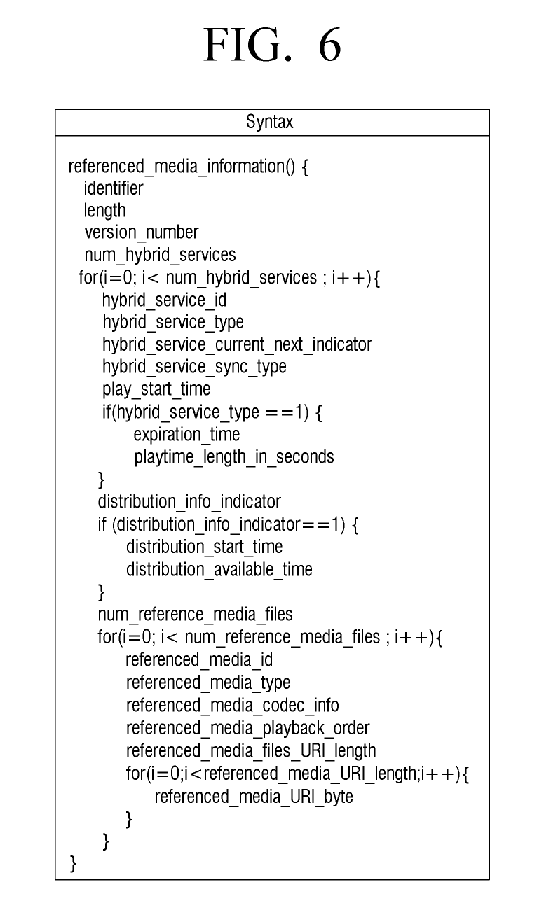

FIG. 6 illustrates syntax of signaling information according to an exemplary embodiment of the present disclosure. Referring to FIG. 6, the signaling information includes num_hybrid_services which means the number of the hybrid service that will be provided, hybrid_service_id which means a separator to distinguish the hybrid service, hybrid_service_type which indicates a providing method of whether the hybrid service is provided in a streaming manner or in a downloading manner, hybrid_service_current_next_indicator which is an indicator to indicate whether the hybrid service is currently being provided or will be provided in the future, namely, the providing timing of the hybrid service, hybrid_service_sync_type which indicates the specific value to specify the synchronization type of the hybrid service, referenced_media_id which is an identifier to indicate reference media that is processed in the hybrid service, referencedmedia_playback_order which indicates temporal playback order of additional data configuring the hybrid service, referenced_media_URI_byte which is URL information to obtain the additional data configuring the hybrid service, etc.

In FIG. 6, the hybrid_service_sync_type may be recorded as the plurality of specific values as explained in FIG. 5.

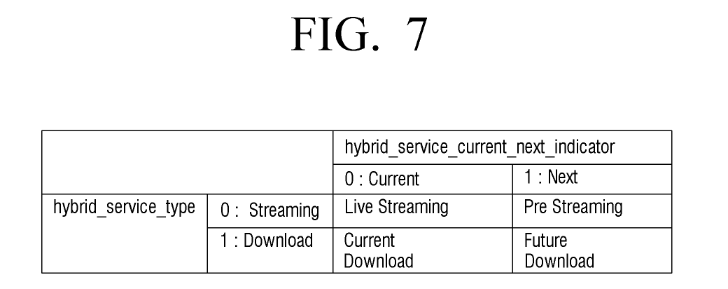

FIG. 7 illustrates an example of the hybrid_service_sync_type and hybrid_service_current_next_indicator among the variables described in FIG. 6. Referring to FIG. 7, if the hybrid_service_sync_type is 0, it is streaming type, and if the hybrid_service_sync_type is 1, it is download type. Also, if the hybrid_service_current_next_indicator is 0, it indicates that the service is currently being output, and if the hybrid_service_current_next_indicator is 1, it indicates that the service will be output next.

As described above, a variety of information may be included in the signaling information, and thus, may be provided to the receiving apparatus 200. The value of the hybrid_service_sync_type of the signaling information may be set differently depending on the synchronizing information that will be used and a transmitting location thereof.

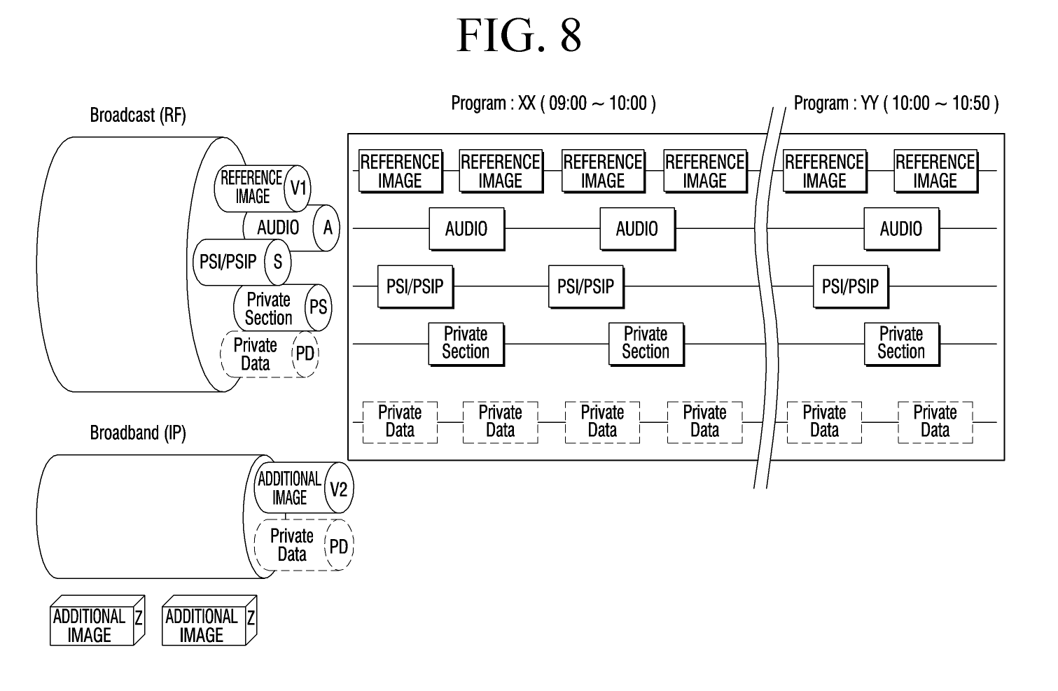

FIG. 8 illustrates a case in which synchronizing information is provided to the receiving apparatus 200 through a separate private data stream. As described above, when the hybrid_service_sync_type is 0x02, the synchronizing information may be transmitted through the private data stream. In this case, the second signal as well as the first signal provides the synchronizing information such as the time code, the frame number, etc. through the private data stream. The receiving apparatus 200 detects the synchronizing information from the private data streams of the first and second signals, and then, synchronizes and outputs the reference data and additional data that are matched to each other.

On the other hand, when the specific value is 0x00, since the reference data and additional data are synchronized based on the PTS information, separate synchronizing information is not provided. Also, when the specific value is 0x01, since the SMPTE time code provided through the ESs of the reference data and additional data is used as the synchronizing information, separate synchronizing information is not provided in the private data stream.

On the other hand, the synchronizing information may be provided in different ways depending on whether the additional data is the transmitting stream (TS) type or the file type.

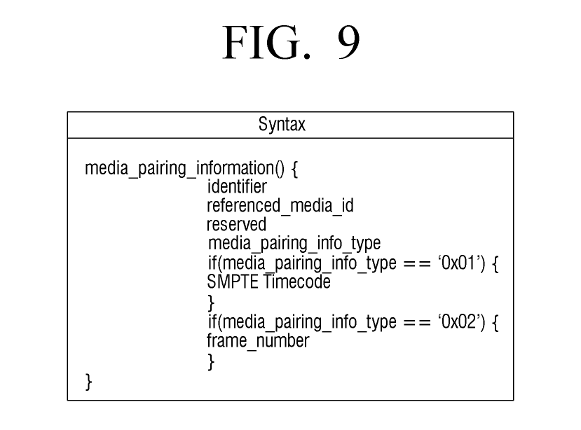

FIG. 9 illustrates a providing format of the second signal in the case of the transmitting stream type. In detail, when the hybrid_service_sync_type is 0x02, the structure of the synchronizing information applied to the TS is illustrated. Referring to FIG. 9, the media_pairing_information includes referenced_media_id which is a user name for specifying reference media, namely, reference data, and a value of media_pairing_info_type which means which one of the time code and the frame number is used in the synchronizing information. If the value of the media_pairing_info_type is 0x01, the synchronization is performed by using the SMPTE time code of the private data stream. If the value of the media_pairing_info_type is 0x02, the synchronization is performed by using the frame number of the private data stream.

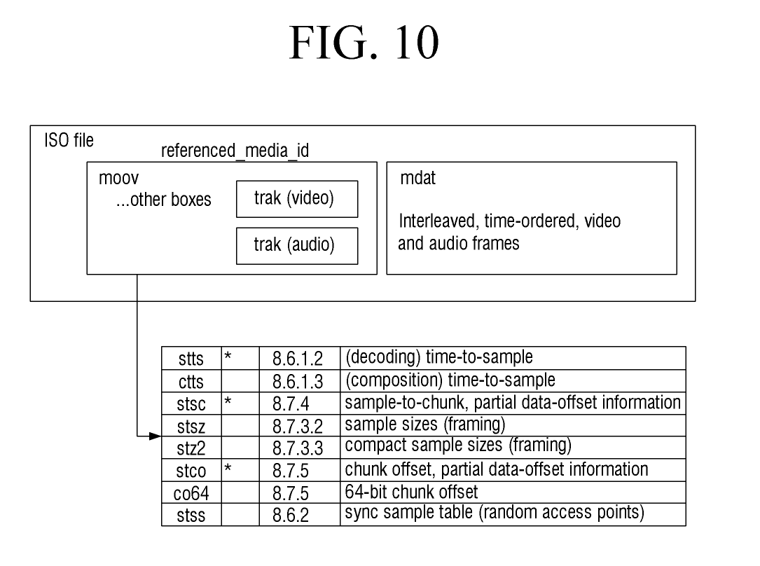

FIG. 10 is a view illustrating a providing format of the second signal based on MP4 that is transmitted through an IP communication network. Referring to FIG. 10, a moov header may tacitly provide values for calculating the frame number by using time-to-sample atom (stts), composition time to sample atom (ctts), and sync sample atom (stns) which provide existing frame playback time information. In other words, a MP4 file provides a relative time value for a playback time from a beginning location of the file like PTS and DTS of the TS through the stts, ctts, and stss. However, since the frame number provides only the relative order between the frames like #1, #2, etc., the frame number does not have specific time units. Accordingly, if the relative time value provided by the stts, ctts, etc. is considered, the order of the frames, namely, the frame numbers may be deduced. Alternatively, by an extension of a separate box, the SMPTE time code or frame number may explicitly be provided. In detail, in an ISO media base file format (14496-12), the time code may be provided by defining an additional box or by extending a field within a predefined box. For example, the time code may be provided by extending a “sync sample table (stss)” box to provide random access.

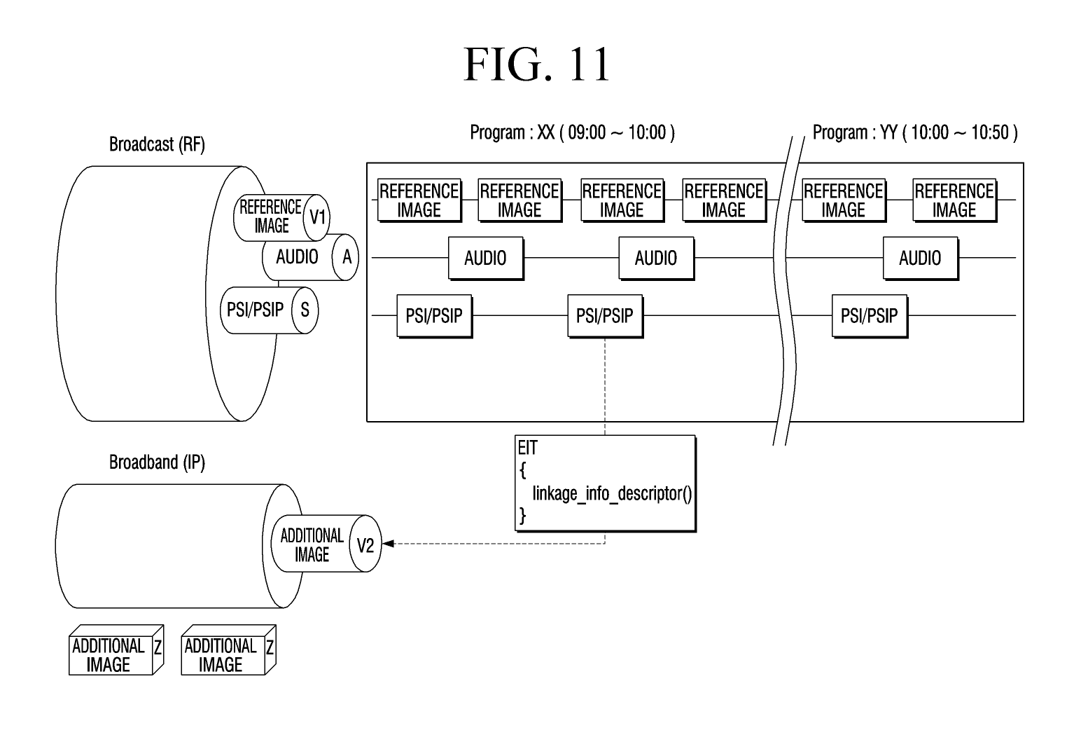

FIG. 11 is a view for explaining another method for transmitting the signaling information. Referring to FIG. 11, linkage_info_descriptor( ) is defined within an event information table (EIT), and thus, the signaling information may be provided by using that. In other words, similar signaling information may be selectively provided through the PSIP or through the EIT, or may be duplicately provided by using both the PSIP and the EIT.

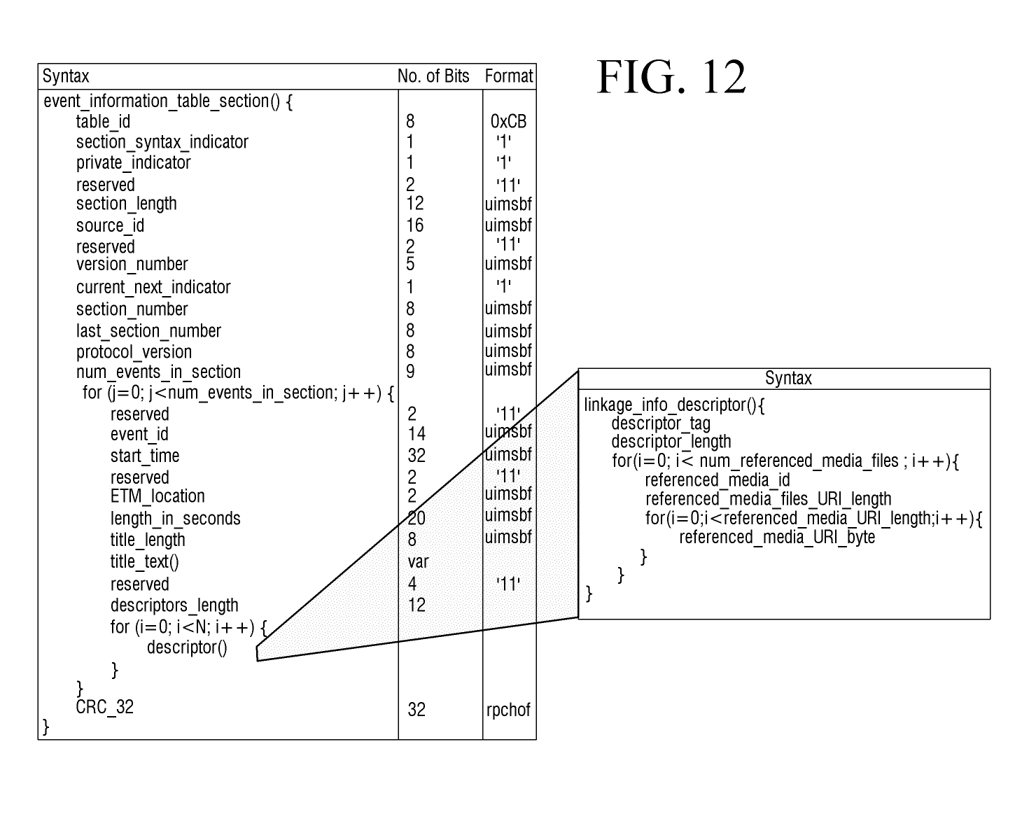

FIG. 12 is a view of an example of a structure of EIT where linkage_info_descriptor( ) is defined. Referring to FIG. 12, the linkage_info_descriptor( ) includes referenced_media_id that is an identifier for the hybrid service, referenced_media_URI_byte that indicates URL information to obtain the additional data of the hybrid service, etc. The receiving apparatus 200 may obtain the additional data by using the information.

According to various exemplary embodiments of the present disclosure as described above, the receiving apparatus may be provided with a plurality of additional data source information by using signaling information. Accordingly, the receiving apparatus may in parallel be provided with the additional data from each of the additional data sources, or may in advance secure the additional data of content that will be serviced in the future. As a result, the delay that is caused to acquire the additional data may be reduced, and also the hybrid service using larger data size of additional data may be supported.

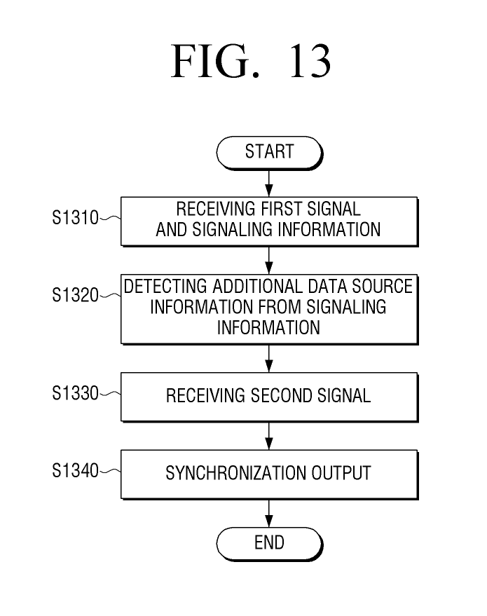

FIG. 13 is a flowchart for explaining a hybrid service providing method in a receiving apparatus according to an exemplary embodiment of the present disclosure. Referring to FIG. 13, the receiving apparatus receives a first signal and signaling information (S1310). The first signal and signaling information may be received through a RF broadcast network. The first signal may include reference data configuring a single content, and the signaling information may include additional data configuring the content with the reference data and a variety of information for the hybrid service that is provided by using the data. The kinds and transmitting methods of the signaling information was described in detail in the above-description; therefore, the duplicate description thereof will be omitted.

The receiving apparatus 200 detects additional data source information from the signaling information (S1320). There may be a plurality of additional data source information. In other words, the plurality of additional data source information may include not only information for a source of at least one additional data corresponding to content that is going to be output or is being output currently, but also information for a source of at least one additional data corresponding to content that will be output next.

The receiving apparatus 200 accesses a source apparatus by using the additional data source information, and then, receives a second signal (S1330). The second signal includes the additional data. The receiving apparatus 200 may access a plurality of source apparatuses, and then, may receive a plurality of additional data.

After that, the receiving apparatus 200 searches data which are synchronized with each other, and then, are output, among the reference data and additional data, and synchronizes and outputs the data. For example, in the case of 3D content, the receiving apparatus 200 searches left eye images and right eye images that are required to be output at the same time, and then, combines and outputs them. On the other hand, if the reference data is video data and the additional data is audio data, the receiving apparatus 200 performs display and speaker output at the same time. Time codes and frame numbers may be used as the synchronizing information. In some cases, in addition to the information, a variety of other information may be used as the synchronizing information. A synchronization type also may vary depending on specific values contained in the signaling information. They were described in detail in the above-description; therefore, the duplicate description thereof will be omitted.

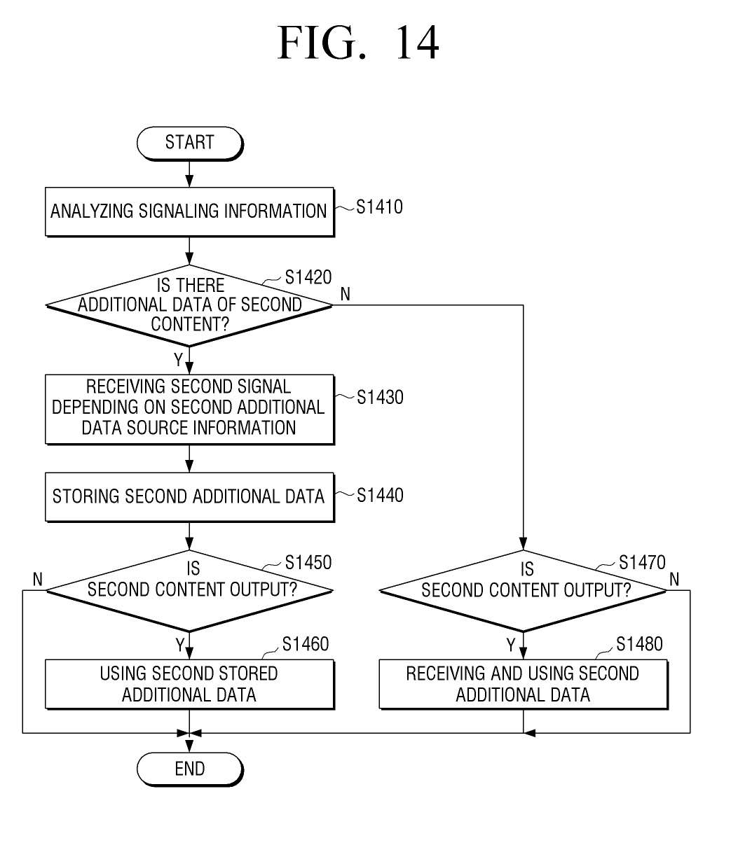

FIG. 14 is a flowchart for explaining a processing method when a plurality of additional data is received. Referring to FIG. 14, the receiving apparatus receives signaling information with reference data of a first content while the first content is being output. The receiving apparatus analyzes the received signaling information (S1410), and then, determines whether there is additional data of a second content (S1420). If the analysis determines that there is second additional data source information within the signaling information, the receiving apparatus accesses a source apparatus depending on the source information, and then, receives a second signal (S1430). Accordingly, after the second signal is received, the receiving apparatus detects and stores second additional data contained in the second signal (S1440).

After that, the output of the first content is ended, and if an event to output the second content starts (S1450), the receiving apparatus receives second reference data for configuring the second content through a RF broadcast network, and then, outputs the second contents by using both the stored second additional data and the second reference data (S1460).

On the other hand, if the second additional data source information does not exist in the signaling information received during the first signal output, the receiving apparatus cannot obtain the second additional data in advance. In this case, when an event to output the second content occurs (S1470), the receiving apparatus receives signaling information corresponding to the second content, and then, checks a source of the second additional data. Accordingly, the receiving apparatus receives the second additional data separately from the second reference data, and then, synchronizes the second additional data with the second reference data, thereby outputting them (S1480).

As described above, the receiving apparatus may properly obtain the reference data and additional data by using the signaling information, and thus, may provide the hybrid service.

On the other hand, the various exemplary embodiments as described above have been described based on the case of processing two contents such as the first content and the second content; however, the additional data may be provided in advance for a plurality of subsequent contents. For example, information for additional data of a third content or a fourth content may be contained in and provided with the signaling information of the first content.

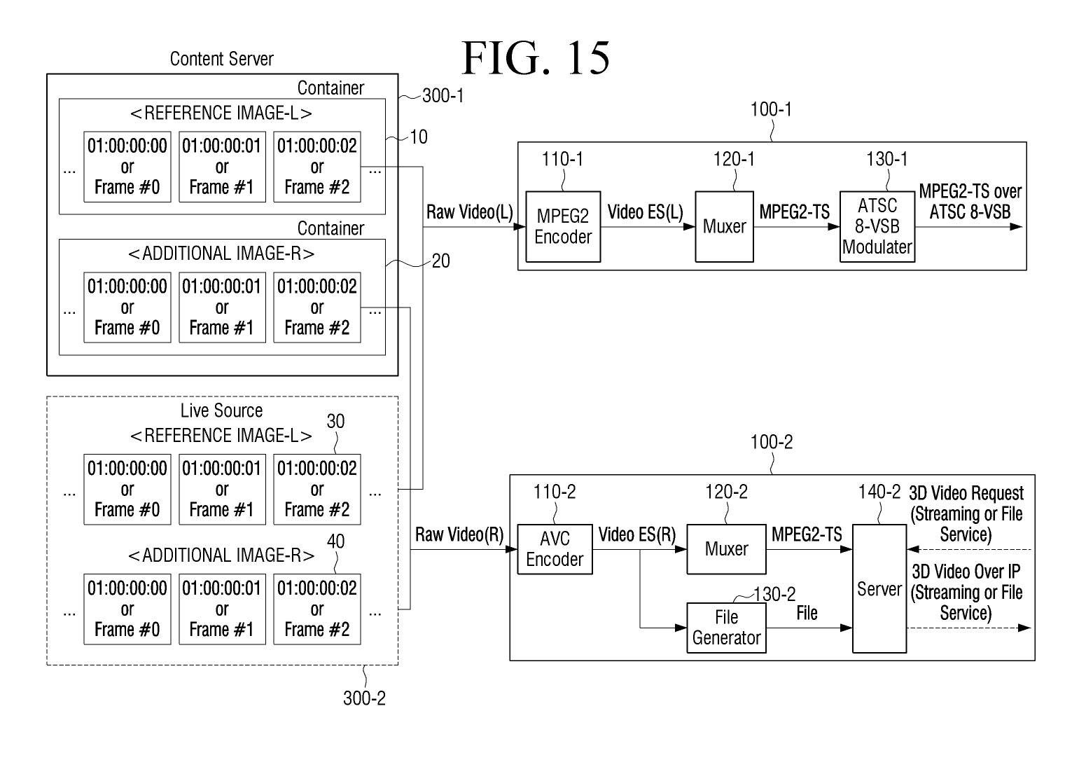

FIG. 15 is a view illustrating an example of a configuration of a transmitting system for providing the above-described hybrid service. Referring to FIG. 15, the transmitting system includes a plurality of source apparatuses 300-1 and 300-2, a first transmitting apparatus 100-1, and a second transmitting apparatus 100-2.

A first source apparatus 300-1 refers to a content server that provides pre-recorded content, and a second source apparatus 300-2 refers to a live source that provides real-time content. The raw video provided from first and second source apparatuses 300-1 and 300-2 includes the synchronizing information in the form of a watermark. FIG. 15 illustrates a state in which time codes that are sequentially assigned to each frame like 01.00.00.00, 01.00.00.01, 01.00.00.02, or frame numbers like frame #1, frame #2, frame #3, are contained in the raw video in the form of a watermark.

Also, FIG. 15 is illustrated so that from each of the first and second source apparatuses 300-1 and 300-2, left eye raw video data is provided to the first transmitting apparatus 100-1, and right eye raw video data is provided to the second transmitting apparatus 100-2. However, this is only one example; therefore, data of the first source apparatus 300-1 may be provided to the first transmitting apparatus 100-1, and data of the second source apparatus 300-2 may be provided to the second transmitting apparatus 100-2.

The first transmitting apparatus 100-1 includes an encoder unit 110-1, a muxer 120-1, and a modulating unit 130-1. The encoder unit 110-1 encodes the raw data in a MPEG 2 encoding manner so as to generate a video elementary stream (ES), and then, provides the video ES to the muxer 120-1. The muxer 120-1 muxes the video ES with various additional data so as to generate a MPEG2-TS (transport stream), and then, provides the MPEG2-TS to the modulating unit 130-1. The modulating unit 130-1 performs modulation in an ATSC 8-VSB modulation manner, and then outputs.

The second transmitting apparatus 100-2 includes an encoder unit 110-2, a muxer 120-2, a file generating unit 130-2, and a server 140-2. The encoder unit 110-2 encodes the raw data in an advanced video coding (AVC) manner so as to generate the video ES. If the content is transmitted in the TS format, the encoder unit 110-2 may provide the video ES to the muxer 120-2. The muxer 120-2 muxes the video ES with various additional data, and then, provides it to the server 140-2.

On the other hand, if transmitting in the MP4 file format, the encoder unit 110-2 may provide the video ES to the file generating unit 130-2. The file generating unit 130-2 converts the video ES into a file format, and then, provides it to the server 140-2.

The server 140-2 stores the video data provided from the muxer 120-2 or the file generating unit 130-2. If a request for the video data (video request) is received from the receiving apparatus 200, depending on the request, the server 140-2 may perform streaming for the stored TS through the IP communication network or may provide the stored file to the receiving apparatus 200 through the IP communication network.

FIG. 15 is illustrated for a configuration in which 3D video data are requested from and provided to the receiving apparatus; however, instead of the 3D video data, 2D video data, audio data, or other data may be processed in the same way.

In FIG. 15, the signaling information including the additional data source information may be inserted in PMT, PSIP VCT, EIT, etc. within the TS or the file by the encoder units 110-1 and 110-2, and the muxers 120-1 and 120-2, or may be generated as a separate private stream. The signaling information may be provided from the first and second source apparatuses 300-1 and 300-2, may be generated by the encoder units 110-1 and 110-2 and the muxers 120-1 and 120-2, and may use the value stored in a storage unit (not illustrated) that is separately disposed. Alternatively, the signaling information may be generated by a control unit (not illustrated) that is separately disposed, and then, may be provided to the encoder units 110-1 and 110-2, or the muxers 120-1 and 120-2. The control unit may generate appropriate signaling information on the characteristics of the system, and thus, may provide it to the encoder units 110-1 and 110-2, or the muxers 120-1 and 120-2.

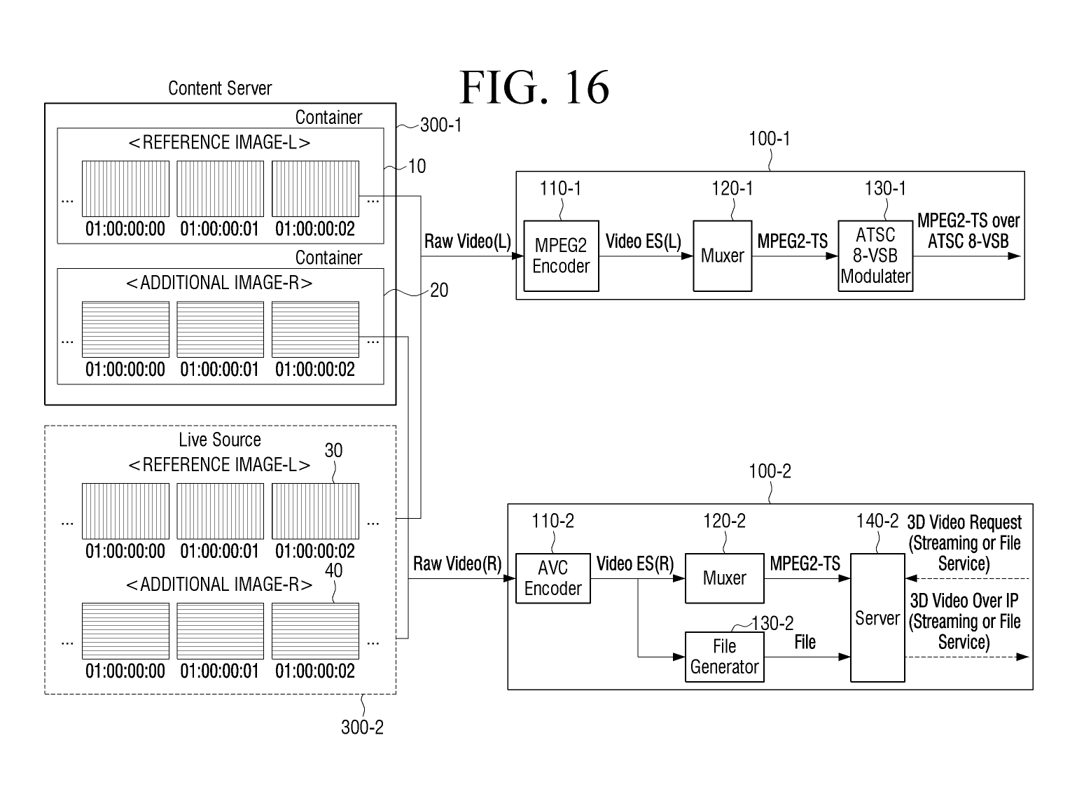

FIG. 16 is a view for explaining a configuration and operation of a transmitting system according to another exemplary embodiment of the present disclosure. Referring to FIG. 16, the transmitting system includes a plurality of source apparatuses 300-1 and 300-2, a first transmitting apparatus 100-1, and a second transmitting apparatus 100-2. The basic configuration of FIG. 16 is the same as that of an embodiment of FIG. 15; therefore, description of the overlapping parts will be omitted.

Referring to FIG. 16, SMPTE time code is included in a vertical blanking interval (VBI) section of raw data that is transmitted from the first source apparatus 300-1 implemented as a content server and the second source apparatus 300-2 implemented as a live source. Accordingly, the MPEG2 encoder 110-1 and the AVC encoder 110-2 included in the first and second transmitting apparatuses 100-1 and 100-2 capture the SMPTE time code, and then, include it in the ES level stream, respectively. Accordingly, the muxers 120-1 and 120-2 and the file generating unit 130-2 generate a TS or a file including the time code in the ES level, and then, provide it to the next component, namely, the modulating unit 130-1 or the server 140-2.

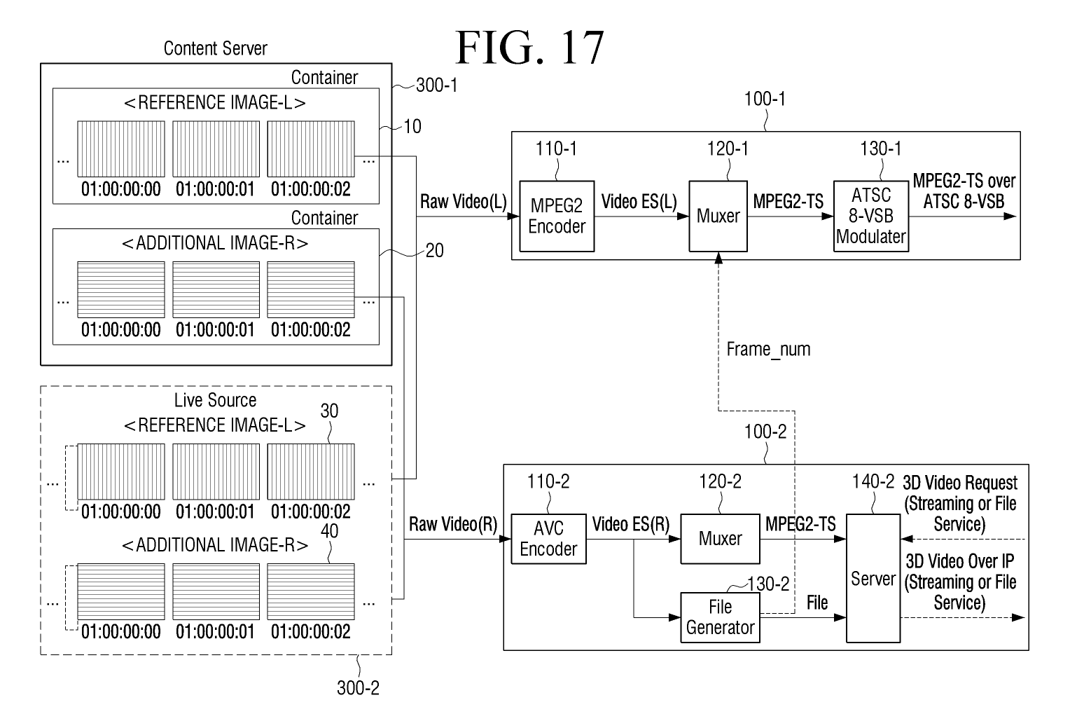

FIG. 17 is a view for explaining configuration and operation of a transmitting system according to still another exemplary embodiment of the present disclosure. The transmitting system as illustrated in FIG. 17 is basically the same as the configuration of the transmitting system as illustrated in FIGS. 15 and 16; therefore, description of the overlapping parts will be omitted.

Referring to FIG. 17, a first source apparatus 300-1 implemented as a content server and a second source apparatus 300-2 implemented as a live source include SMPTE time codes or a separate start marker to instruct a starting point of a program unit in a VBI section of the raw video data. For example, if the synchronizing information is the SMPTE time code, the MPEG2 encoder 110-1 and the AVC encoder 110-2 capture the SMPTE time code contained in the VBI section of the raw video data, and then, include it in the ES level stream, respectively. On the other hand, if the synchronizing information is the frame number, the file generating unit 130-2 recognizes the start marker, and then, provides a generated frame number to the muxer 120-1 within the first transmitting apparatus 100-1. Accordingly, the value of the frame number may be included in a first signal.

In FIG. 17, a subject that generates and inserts the PES level synchronizing information may be variously determined depending on whether transmitting stream or MP4 file. For example, in the case of the transmitting stream, the subject may be either an encoder or a muxer, or the encoder may directly generate separate PES. Alternatively, the muxer may extract time codes, frame numbers, etc., which are transmitted in the ES level, and may generate PES-level synchronizing information. On the other hand, in the case of the MP4 file, the time code, frame number, etc. that is transmitted in the ES level is extracted through the encoder, and then, the file generator may expend one portion within Moov of a file format and may insert the corresponding information in the portion. The intermediate processing for generating the stream as described above may be combined or configured in a variety of ways.

The receiving apparatus analyzes the signaling information provided from various configurations of the transmitting system as illustrated in FIGS. 15, 16, and 17, detects the additional data source information, accesses the source apparatus corresponding to the additional data source information, and receives the additional data. The configuration and operation of the receiving apparatus are explained in detail in the description for FIGS. 1 and 2; therefore, duplicate description thereof will be omitted.

The above-described transmitting/receiving system may be applied in a variety of environments to transmit and receive different data. In other words, in addition to 3D content consisting of left eye images and right eye images, it may be used in a variety of hybrid services that divides and transmit content based on the broadcast network and the network.

For example, the transmitting/receiving system may be applied to a data broadcast service system that transmits 2D broadcast through the broadcast network and transmits data such as multi-language audio, multi-language subtitles, etc. through the network. Also, the transmitting/receiving system may be applied to an ultra-high definition (UHD) broadcast service system that transmits the 2D broadcast through the broadcast network and transmits UHD broadcast data through the network. In addition, the transmitting/receiving system may be applied to a multi-view broadcast service system that transmits the 2D broadcast through the broadcast network and transmits data such as depth maps, another point of view, etc. through the network, or a multi-angle service system that transmits the 2D broadcast through the broadcast network and provides image data of different shooting angles through the network.

Also, in the above-described embodiments, the 2D broadcast is described to be transmitted only through the broadcast network; however, this is only one example to take advantage of the existing broadcast system, and does not limit the present disclosure. In other words, the multi-language audio, multi-language subtitles, UHD broadcast data, depth maps data, another point of view data, etc. corresponding to the 2D content data may be transmitted through the broadcast network.

Also, the above-described various exemplary embodiments describe the hybrid system using both the RF broadcast network and the IP communication network; however, there may be other kinds of communication networks.

The signal process methods of the transmitting apparatus and the receiving apparatus according to various exemplary embodiments as described above may be coded as software, and thus, may be mounted in a variety of apparatuses.

In detail, according to an exemplary embodiment of the present disclosure, a non-transitory computer-readable medium in which a program that performs a step of receiving a first signal including reference data, and signaling information through a RF broadcast network, a step of detecting a plurality of additional data source information from the signaling information, a step of accessing an internet protocol communication network, and receiving a second signal including additional data from a source apparatus corresponding to each of the plurality of additional data source information, and a step of detecting, processing, synchronizing, and outputting the reference data and the additional data from the first signal and the second signal is stored may be disposed in the variety of apparatuses.

The non-transitory computer-readable medium is not a medium to store data for a short moment like a register, a cache, a memory, etc., but represents, for example, a medium that can store data semi-permanently and can be read by devices. In detail, the various applications or programs as described above may be stored in the non-transitory computer readable medium, such as a compact disc (CD), a digital versatile disc (DVD), a hard disc, a Blu-ray disc, a universal serial bus (USB), a memory card, a ROM, etc.

While exemplary embodiments of the present disclosure have been described, additional variations and modifications of the exemplary embodiments may occur to those skilled in the art once they learn of the basic inventive concepts. Therefore, it is intended that the appended claims shall be construed to include both the above exemplary embodiments and all such variations and modifications that fall within the spirit and scope of the inventive concepts.

What is claimed is:

1. An apparatus comprising:
a first receiver configured to receive signaling information and a first signal comprising reference data through a first network;
a controller configured to detect a plurality of additional data source information from the signaling information;
a second receiver configured to access a second network, and receive a second signal comprising additional data from a source apparatus corresponding to each of the plurality of additional data source information;
a storage which stores the reference data contained in the first signal and the additional data contained in the second signal; and
an outputter configured to process, synchronize and output each of the reference data and additional data.

2. The apparatus of claim 1, wherein
the signaling information comprises first additional data source information related to a source of at least one first additional data of a first content and second additional data source information related to a source of at least one second additional data of a second content that will be output following the first content, and
the signaling information corresponding to each content is repeatedly received while corresponding content is being output.

3. The apparatus of claim 2, wherein
while the first content is being output, the controller controls the second receiver to access the source of the at least one second additional data by using the second additional data source information and to receive the second signal comprising the second additional data, and store the second additional data in the storage.

4. The apparatus of claim 2, wherein
the signaling information comprises a specific value related to a synchronization type of a hybrid service, and
the controller controls the outputter so that the reference data and the additional data are synchronized and output, by using synchronizing information corresponding to the specific value.

5. The apparatus of claim 4, wherein
the specific value comprises a first value that relates to performing synchronization by using presentation time stamp (PTS) information of each of the reference data and the additional data, a second value that relates to using time codes contained in an elementary stream (ES) of each of the reference data and the additional data as the synchronizing information, and a third value that relates to using the synchronizing information provided through a private data stream contained in each of the first and second signals.

6. The receiving apparatus of claim 5, wherein,
if the specific value is the first value, the outputter selects unit data that will be synchronized by comparing PTS of the reference data and PTS of the additional data, and outputs the selected unit data,
if the specific value is the second value, the outputter selects the unit data that will be synchronized by comparing a first time code contained in the ES of the reference data and a second time code contained in the ES of the additional data, adjusts timestamps of the selected unit data to a same value, and performs synchronization output based on the adjusted timestamp, and,
if the specific value is the third value, the outputter detects the synchronizing information contained in each private data stream, and performs synchronization output depending on the detected synchronizing information.

7. The apparatus of claim 3, wherein
the signaling information comprises at least one from among a number of hybrid services provided by using the signaling information, a separator of the hybrid service, a providing method of the hybrid service, an indicator to indicate a providing time of the hybrid service, a specific value to specify a synchronization type of the hybrid service, an identifier of the hybrid service, a temporal order of playback of additional data configuring the hybrid service, and an URL information to obtain additional data.

8. The apparatus of claim 4, wherein
the outputter comprises;
a first detector configured to detect the reference data from the first signal;
a first video processor configured to decode the reference data and generate a first video frame;
a second detector configured to detect the additional data from the second signal;
a second video processor configured to decode the additional data and generate a second video frame; and
a renderer configured to combine the first decoded video frame and the second decoded video frame and perform rendering,
wherein the controller selectively controls at least one from among the first detector, the second detector, the first video processor, the second video processor, and the renderer, and performs synchronization processing of the reference data and the additional data.

9. The apparatus of claim 1, wherein
the controller detects the signaling information from at least one from among a reserved area within a program map table (PMT), a PMT descriptor area, a program and system information protocol virtual channel table (PSIP VCT), an event information table (EIT) reserved, an EIT descriptor area, and a private stream.

10. A hybrid service providing method, comprising:
receiving signaling information and a first signal comprising reference data through a first network;
detecting a plurality of additional data source information from the signaling information;
receiving a second signal comprising additional data from a source apparatus corresponding to each of the plurality of additional data source information by accessing a second network; and
detecting the reference data and the additional data from each of the first signal and the second signal, respectively, and processing, synchronizing, and outputting the reference data and the additional data.

11. The hybrid service providing method of claim 10, wherein
the signaling information comprises first additional data source information related to a source of at least one first additional data of a first content and a second additional data source information related to a source of at least one second additional data of a second content that will be output following the first content, and
the signaling information corresponding to each content is repeatedly received in a same form while corresponding content is being output.

12. The hybrid service providing method of claim 11, further comprising:
storing the second additional data if the second signal comprising the second additional data is received based on the second additional data source information while the first content is being output; and
outputting, if an event to output the second content occurs, the second content by using the stored second additional data.

13. The hybrid service providing method of claim 11, wherein
the signaling information comprises a specific value related to a synchronization type of a hybrid service, and
the synchronizing is performed depending on synchronizing information corresponding to the specific value.

14. The hybrid service providing method of claim 13, wherein
the specific value comprises a first value related to performing synchronization by using presentation time stamp (PTS) information of each of the reference data and the additional data, a second value related to using time codes contained in an elementary stream (ES) of each of the reference data and the additional data as the synchronizing information, and a third value related to using the synchronizing information provided through a private data stream contained in each of the first and second signals.

15. The hybrid service providing method of claim 14, wherein,
the outputting comprises,
if the specific value is the first value, selecting unit data that will be synchronized by comparing PTS of the reference data and PTS of the additional data, and outputting the selected unit data;
if the specific value is the second value, selecting the unit data that will be synchronized by comparing a first time code contained in the ES of the reference data and a second time code contained in the ES of the additional data, adjusting timestamps of the selected unit data to a same value, and performing synchronization output based on the adjusted timestamp; and
if the specific value is the third value, detecting the synchronizing information contained in each private data stream, and performing synchronization output depending on the detected synchronizing information.

16. The hybrid service providing method of claim 11, wherein
the signaling information comprises at least one from among a number of hybrid services provided by using the signaling information, a separator of the hybrid service, a providing method of the hybrid service, an indicator to indicate a providing time of the hybrid service, a specific value to specify a synchronization type of the hybrid service, an identifier of the hybrid service, a temporal order of playback of additional data configuring the hybrid service, and an URL information to obtain the additional data.

17. The hybrid service providing method of claim 10, wherein
the signaling information is detected from at least one of a reserved area within a program map table (PMT), a PMT descriptor area, a program and system information protocol virtual channel table (PSIP VCT), an event information table (EIT) reserved, an EIT descriptor area, and a private stream.

18. The apparatus of claim 1, wherein the first network is a radio frequency broadcast network and the second network is an internet protocol communication network.

19. The hybrid service providing method of claim 10, wherein the first network is a radio frequency broadcast network and the second network is an internet protocol communication network.
